(19) United States
(12) Patent Application Publication
(10) Pub. No.: US 2024/0006754 A1
(43) Pub. Date: Jan. 4, 2024

(54) ANTENNA DEVICE

(71) Applicant: KABUSHIKI KAISHA TOKAI RIKA DENKI SEISAKUSHO, Aichi (JP)

(72) Inventors: Yuki KONO, Aichi (JP); Tadashi FUKAGAI, Aichi (JP); Masateru FURUTA, Aichi (JP); Yutaka KUBO, Aichi (JP)

(73) Assignee: KABUSHIKI KAISHA TOKAI RIKA DENKI SEISAKUSHO, Aichi (JP)

(21) Appl. No.: 18/212,921

(22) Filed: Jun. 22, 2023

(30) Foreign Application Priority Data
Jul. 4, 2022 (JP) 2022-107598

(51) Int. Cl. H01Q 1/44; H01Q 1/24

(52) U.S. Cl. CPC H01Q 1/44; H01Q 1/243

(57) ABSTRACT

There is provided an antenna device comprising: a chip antenna that is disposed on a substrate; and a metal element that is disposed above or below the chip antenna in a direction orthogonal to a plane of the substrate.

### CROSS REFERENCE TO RELATED APPLICATION(S)

This application is based upon and claims benefit of priority from Japanese Patent Application No. 2022-107598, filed on Jul. 4, 2022, the entire contents of which are incorporated herein by reference.

### BACKGROUND

The present invention relates to an antenna device.

In recent years, various devices with a wireless communication function have been produced. In addition, antennas have been actively developed to realize a wireless communication function in devices. The antennas include, for example, a chip antenna disclosed in JP 2019-213138 A.

### SUMMARY

In the chip antenna disclosed in Patent Document 1, directivity of a transmitted signal is determined by an electric field formed according to a direction of current flow. For example, in a general chip antenna, since a current flows parallel to a substrate plane, it is difficult to form substantially uniform directivity of a signal in the entire circumferential direction of the substrate plane.

Therefore, the present invention has been made in view of the above problems, and an object of the present invention is to form substantially uniform directivity of a signal in the entire circumferential direction of a substrate plane with a simple configuration.

To solve the above described problem, according to an aspect of the present invention, there is provided an antenna device comprising: a chip antenna that is disposed on a substrate; and a metal element that is disposed above or below the chip antenna in a direction orthogonal to a plane of the substrate.

As described above, according to the present invention, it is possible to form substantially uniform directivity of a signal in the entire circumferential direction of the substrate plane with a simple configuration.

### BRIEF DESCRIPTION OF THE DRAWINGS

FIG. 1 is a diagram for explaining directivity of a signal transmitted by a chip antenna.

FIG. 2 is a view for explaining a configuration example of an antenna device according to an embodiment of the present invention.

FIG. 3 is a view showing an arrangement example of a chip antenna 120 and a metal element 130 according to the same embodiment.

FIG. 4 is a diagram showing directivity of an H-polarized wave and a V-polarized wave in a comparison device having a chip antenna and a metal element which do not satisfy arrangement conditions according to the same embodiment.

FIG. 5 is a diagram showing directivity of an H-polarized wave and a V-polarized wave in the antenna device 10 having the chip antenna 120 and the metal element 130 which satisfy arrangement conditions according to the same embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

### 1.1. Background

As described above, in recent years, antennas have been actively developed for realizing a wireless communication function in devices.

The antennas include, for example, a chip antenna disposed on a substrate. The chip antenna is made of dielectric ceramics for high frequencies, for example, and is excellent in miniaturization and broadband performance.

Directivity of a signal transmitted by the chip antenna is determined by an electric field formed according to a direction of a current flowing through an antenna element, similar to a general half-wavelength (λ/2) dipole antenna or a general grounded λ/4 monopole antenna.

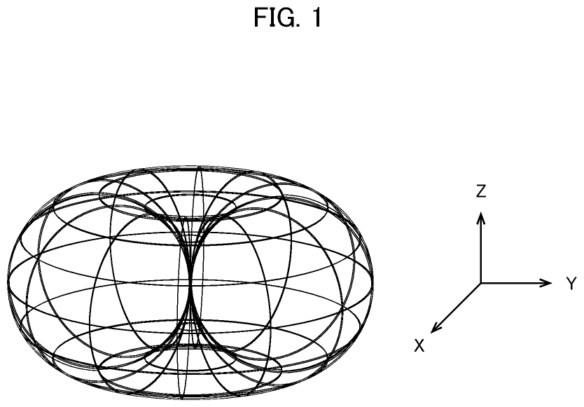

FIG. 1 is a diagram for explaining the directivity of the signal transmitted by the chip antenna.

FIG. 1 shows an image expressing the directivity of a transmission signal on three axes, an X axis, a Y axis, and a Z axis, centered on the chip antenna.

In addition, in FIG. 1, the directivity of the transmission signal in a case where the current flows in the Z-axis direction in the chip antenna is expressed.

In this case, as shown in the figure, on a two-dimensional plane formed by the X axis and Y axis, the directivity of the transmission signal is formed substantially uniformly in the entire circumferential direction of the chip antenna, whereas in the Z-axis direction, the directivity of the transmission signal is weakened.

Moreover, the chip antenna is usually disposed on the substrate such that the antenna element included in the chip antenna is parallel to the substrate.

That is, in a general chip antenna, since the current flows parallel to the substrate, the directivity of the transmission signal in the direction in which the current flows is weakened, and as a result, it is difficult to form substantially uniform directivity of the transmission signal in the entire circumferential direction of a substrate plane.

However, depending on the application of the device in which the chip antenna is installed, it may be desirable to form substantially uniform directivity of the transmission signal in the entire circumferential direction of the substrate plane.

For example, it is assumed that a chip antenna is installed in a portable device of a user and the portable device is provided with a wireless communication function.

The portable device may be, for example, a device that performs wireless communication with a moving body such as a vehicle.

Further, in this case, the moving body may perform wireless communication with, for example, a portable device, and perform various controls based on the result of the wireless communication.

Examples of the above-described controls include an unlocking control of a door of a moving body and a starting control of an engine.

For example, the moving body may perform the unlocking control of a door and the starting control of an engine in a case where the authenticity of the portable device is recognized on the basis of the result of wireless communication.

Further, for example, the moving body may perform the unlocking control of a door and the starting control of an engine in a case where it is estimated that the distance between the portable device and the moving body is equal to or less than a specified distance on the basis of the result of wireless communication.

However, in a case where the moving body performs the control as described above, it is required that wireless communication be maintained between the portable device and the moving body.

In a case where wireless communication between the portable device and the moving body becomes impossible, or in a case where the quality of wireless communication drops significantly, the moving body will not be able to properly determine the authenticity of the portable device and estimate the distance as described above, and as a result, it will be difficult to properly control the door and the engine.

In order to avoid the situation described above, it is important, for example, for the signal transmitted from the chip antenna installed in the portable device to be received by an antenna installed in the moving body with good sensitivity.

However, for example, in a case where the user puts the portable device in his or her pocket, either the front surface or the rear surface of the portable device usually faces the user.

In this case, in the chip antenna disposed on the substrate installed parallel to the front and rear surfaces of the portable device, the current flows parallel to the front and rear surfaces of the portable device, and thus an H-polarized wave (a horizontally polarized wave), which is an electric field component parallel to the substrate, increases.

However, the H-polarized wave in the above situation is likely to be affected by the human body of the user facing either the front surface or the rear surface of the portable device, and thus deterioration in characteristics (a reduction in gain) is likely to occur.

In this case, the antenna installed in the moving body cannot receive the signal transmitted from the chip antenna installed in the portable device with good sensitivity, and there is a possibility of the above-described control becoming impossible.

For the above reasons, in a case where the chip antenna is installed in the portable device, it is important to increase not only the H-polarized wave but also a V-polarized wave (a vertically polarized wave), which is an electric field component perpendicular to the substrate and the human body.

According to this, even in a case where the H-polarized wave is likely to be affected by the human body in the situation described above, it is possible to form the directivity of the transmission signal in the entire circumferential direction of the substrate plane, and it is possible to establish wireless communication using the V-polarized wave which is not likely to be affected by the human body.

A configuration example of an antenna device 10 according to the present embodiment that realizes the above will be described in detail below.

### 1.2. Configuration Example

The antenna device 10 according to the present embodiment is a device that transmits and receives a radio signal to and from an antenna installed in another device.

For example, the antenna device 10 according to the present embodiment may be installed in a portable device carried by a user. In this case, the antenna device 10 according to the present embodiment may transmit and receive a radio signal to and from the antenna installed in the moving body as described above.

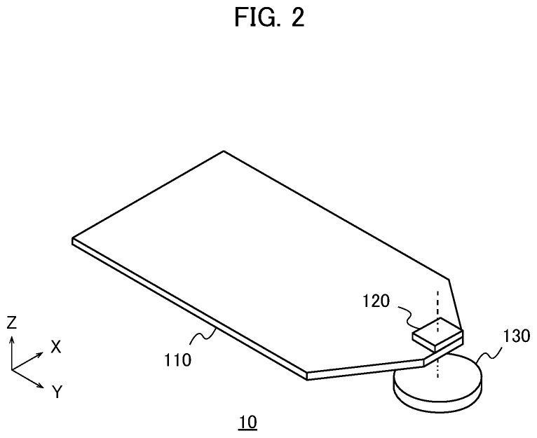

FIG. 2 is a view for explaining the configuration example of the antenna device 10 according to the present embodiment. As shown in FIG. 2, the antenna device 10 according to the present embodiment includes a chip antenna 120 disposed on a substrate 110 and a metal element 130.

In FIG. 2, description of other configurations that can be disposed on the substrate 110 is omitted.

Further, in FIG. 2, the chip antenna 120 and the metal element 130 are emphasized for convenience of explanation. The dimensions of the chip antenna 120 and the metal element 130 relative to substrate 110 are not specified in the example shown in FIG. 2.

In addition, the same also applies to the shapes of the chip antenna 120 and the metal element 130 according to the present embodiment. The chip antenna 120 and the metal element 130 according to the present embodiment may be formed in shapes different from those shown in FIG. 2.

### (Chip Antenna 120)

The chip antenna 120 according to the present embodiment transmits a signal conforming to the specified wireless communication standard.

Examples of the above specified communication standard include an ultra-wide band (UWB) wireless communication. In a case where the ultra-wide band wireless communication is adopted as the specified communication standard, the chip antenna according to the present embodiment transmits a signal in an ultra-wide band.

On the other hand, the specified communication standard according to the present embodiment is not limited to the above example. The chip antenna 120 according to the present embodiment may transmit, for example, a signal in a low frequency (LF) band or a signal in an ultra high frequency (UHF) band.

### (Metal Element 130)

The metal element 130 according to the present embodiment is formed using a conductive metal.

Further, the metal element 130 according to the present embodiment may be a component originally provided in the portable device in which the antenna device 10 is installed.

As an example, the metal element 130 according to the present embodiment may be a battery that supplies electric power to the chip antenna 120.

When a component that is originally necessary for manufacturing a portable device, such as a battery, is used as the metal element 130 according to the present embodiment, it is possible to obtain the effects, which will be described later, without separately manufacturing a new component and even in a case where the space inside a device is limited like the portable device.

The metal element 130 according to the present embodiment is not limited to a battery and may be, for example, a metal decoration that accompanies a casing of a portable device.

Moreover, one of the characteristics of the metal element 130 according to the present embodiment is that it is disposed above or below the chip antenna 120 in a direction orthogonal to the plane of the substrate 110.

In the example shown in FIG. 2, the metal element 130 is disposed below the chip antenna 120 with the substrate 110 interposed therebetween in the direction orthogonal to the plane of the substrate 110.

According to the arrangement described above, when the metal element 130 resonates with the electric field formed by the current flowing parallel to the substrate 110 in the chip antenna 120, an electric field is also generated in the metal element 130.

At this time, the electric field generated in the metal element 130 has many components of the V-polarized wave orthogonal to the plane of the substrate 110.

According to the above operation, it is possible to form substantially uniform signal directivity in the entire circumferential direction of the substrate 110.

Further, as described above, even in a case where the H-polarized wave is likely to be affected by the human body, it is possible to establish wireless communication using the V-polarized wave which is not likely to be affected by the human body.

In order to realize the above, it is important to effectively resonate the metal element 130.

For this reason, the metal element 130 according to the present embodiment may be disposed to satisfy the conditions which will be described below.

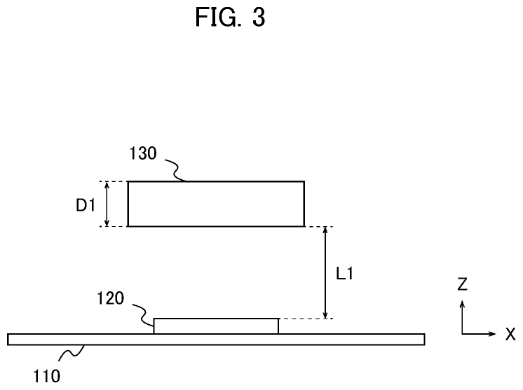

FIG. 3 is a view showing an arrangement example of the chip antenna 120 and the metal element 130 according to the present embodiment.

For example, the metal element 130 according to the present embodiment may be disposed such that a distance L1 between the metal element 130 and the chip antenna 120 is shorter than a specified length determined according to a frequency of the signal transmitted by the chip antenna 120.

Here, the specified length may be a quarter of a wavelength according to the frequency of the signal transmitted by the chip antenna 120.

In this case, the metal element 130 according to the present embodiment may be disposed such that a distance L1 between the metal element 130 and the chip antenna 120 is shorter than a quarter of the wavelength according to the frequency of the signal transmitted by the chip antenna 120.

That is, the metal elements 130 according to the present embodiment may be disposed to satisfy the distance L1<λ/4.

According to the arrangement described above, it is possible to effectively resonate the metal element 130, and it is possible to effectively increase the V-polarized wave.

In addition, for example, in a case where the metal element 130 is disposed below the chip antenna with the substrate 110 interposed therebetween and a GND is formed on the lower surface of the substrate 110, the metal element 130 may be disposed such that a distance between the metal element 130 and the GND is less than λ/4. In such a case, the GND can be regarded as a part of the chip antenna 120.

Further, in addition to the above conditions, the metal element 130 according to the present embodiment may be formed such that a thickness D1 in the direction orthogonal to the plane of the substrate 110 satisfies specified conditions determined by the frequency of the signal transmitted by the chip antenna 120.

As an example, the metal element 130 according to the present embodiment may be formed such that a thickness D1 in the direction orthogonal to the plane of the substrate 110 is equal to or less than the wavelength according to the frequency of the signal transmitted by the chip antenna 120.

That is, the metal element 130 according to the present embodiment may be formed to satisfy the thickness D1<2.

According to the shape described above, it is possible to effectively resonate the metal element 130, and it is possible to effectively increase the V-polarized wave.

Furthermore, the metal element 130 may be formed such that the thickness D1 has a length suitable to be cut-off for the wavelength such as λ/4, λ/2, 3λ/4, and λ.

According to this, it is possible to realize the resonance of the metal element 130 more effectively.

According to the shape and the arrangement described above, it is possible to increase the component of the current flowing in a direction perpendicular to the substrate 110 (in the case of the example shown in FIG. 3, the Z-axis direction), and it is possible to more effectively form substantially uniform directivity of the transmission signal in the entire circumferential direction of the substrate 110.

Furthermore, it is desirable to arrange the metal element 130 according to the present embodiment as close as possible to a feeding point from which electric power is supplied to the chip antenna 120.

For example, in a case where it is structurally difficult to bring the feeding point 125 and the metal element 130 according to the present embodiment into contact with each other, the metal element 130 may be disposed such that a distance L3 between the metal element and the feeding point is longer than 0 and the metal element 130 is in close proximity to the feeding point 125.

According to the arrangement described above, it is possible to effectively increase the component of the current flowing in the direction perpendicular to the substrate 110.

### 1.3. Effects

Next, the effects exhibited by the antenna device 10 according to the present embodiment will be described in detail.

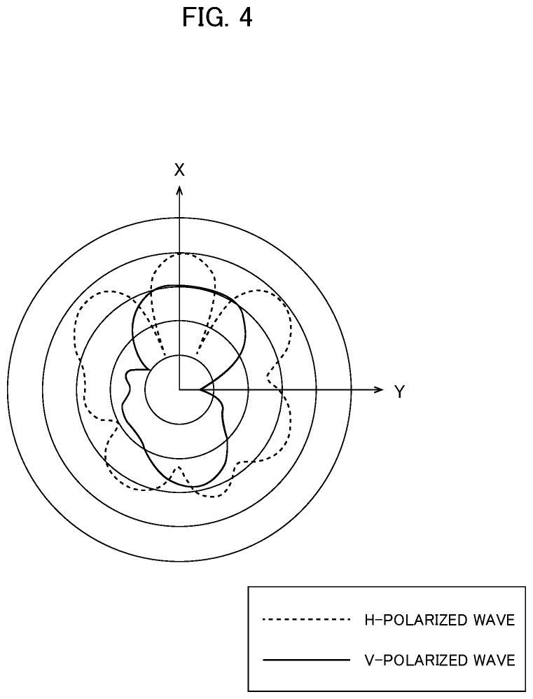

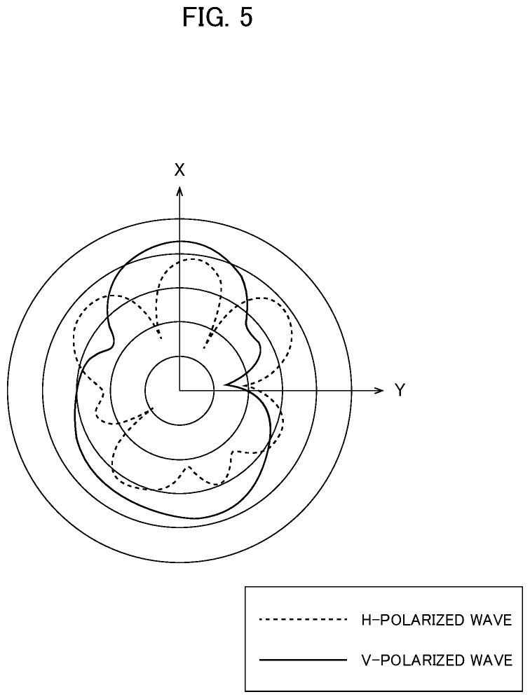

FIGS. 4 and 5 are diagrams for explaining the effects exhibited by the antenna device 10 including the metal element 130 according to the present embodiment.

FIG. 4 shows a graph showing the directivity of the H-polarized wave and the V-polarized wave in an antenna device having a chip antenna and a metal element which do not satisfy the arrangement conditions described above (hereinafter referred to as a comparison device).

Referring to FIG. 4, it can be seen that in the comparison device, a component of the V-polarized wave is relatively smaller than that of the H-polarized wave in the entire circumferential direction of the substrate (each direction on a horizontal plane specified by the X axis and the Y axis), and particularly the component of the V-polarized wave in the Y-axis direction is remarkably small.

On the other hand, FIG. 5 shows a graph showing the directivity of the H-polarized wave and the V-polarized wave in the antenna device 10 including the chip antenna 120 and the metal element 130 which satisfy the arrangement conditions described above according to the present embodiment.

Referring to FIG. 5, it can be seen that in the antenna device 10 according to the present embodiment, the component of the V-polarized wave increases as a whole in the entire circumferential direction of the substrate 110 (each direction on a horizontal plane specified by the X axis and the Y axis) as compared with the comparison device.

As described above, according to the antenna device 10 including the metal element 130 according to the present embodiment, it is possible to form substantially uniform directivity of a signal in the entire circumferential direction of the surface of the substrate 110 with a simple configuration in which a battery or the like that is originally provided in a portable device is used as the metal element 130 even in a case where the space inside a device is limited like the portable device.

Further, as described above, even in a case where the H-polarized wave is likely to be affected by the human body, it is possible to establish wireless communication using the V-polarized wave which is not likely to be affected by the human body.

### 2. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

What is claimed is:

1. An antenna device comprising:
a chip antenna that is disposed on a substrate; and
a metal element that is disposed above or below the chip antenna in a direction orthogonal to a plane of the substrate.

2. The antenna device according to claim 1, wherein the metal element is disposed such that a distance between the metal element and the chip antenna is shorter than a specified length determined according to a frequency of a signal transmitted by the chip antenna.

3. The antenna device according to claim 2, wherein the metal element is disposed such that a distance between the metal element and the chip antenna is shorter than a quarter of a wavelength according to a frequency of a signal transmitted by the chip antenna.

4. The antenna device according to claim 1, wherein the metal element is formed such that a thickness in a direction orthogonal to a plane of the substrate satisfies specified conditions determined by a frequency of a signal transmitted by the chip antenna.

5. The antenna device according to claim 4, wherein the metal element is formed such that a thickness in a direction orthogonal to a plane of the substrate is equal to or less than a wavelength according to a frequency of a signal transmitted by the chip antenna.

6. The antenna device according to claim 1, wherein the metal element is a battery that supplies electric power to the chip antenna.

7. The antenna device according to claim 1, which is installed in a portable device carried by a user.

8. The antenna device according to claim 1, wherein the chip antenna transmits a signal in an ultra-wide band signal.
